(19) United States
(12) Patent Application Publication
(10) Pub. No.: US 2010/0143793 A1
(43) Pub. Date: Jun. 10, 2010

(54) Battery Pack

(76) Inventor: Hiroshi Yamamoto, Osaka (JP)

Correspondence Address: BIRCH STEWART KOLASCH & BIRCH, PO BOX 747, FALLS CHURCH, VA, 22040-0747, US

(21) Appl. No.: 11/884,355

(22) PCT Filed: May 2, 2006
(86) PCT No.: PCT/JP2006/309154

§ 371 Date: Aug. 15, 2007

(30) Foreign Application Priority Data
May 25, 2005 (JP) 2005-153132
May 25, 2005 (JP) 2005-153134

(51) Int. Cl. H01M 2/04

(52) U.S. Cl. 429/175

(57) ABSTRACT

The battery pack of the present invention includes a circuit board placed on the upper side of a unit cell, an upper cover placed on the upper side of the circuit board, and a resin mold that is formed in between the upper cover and the upper surface of the unit cell and integrates the circuit board and the upper cover with the upper surface of the unit cell. External connection terminals for connection with the contact terminals of external equipment are placed on the upper surface of the circuit board, and the upper cover has a window that is provided in a penetrating form facing the external connection terminals. In order to regulate a spacing between the upper cover and the upper surface of the unit cell, a positioning projection is provided directed downward at both right and left ends on the lower surface of the upper cover, and a board fitting portion in which the circuit board is fit is formed on the lower surface of the upper cover.

### BACKGROUND OF THE INVENTION

The present invention relates to a battery pack in which a circuit board is placed on the upper side of a unit cell, and an upper cover is placed on the upper side of the circuit board, the circuit board and the upper cover being integrated with each other on the upper surface of the unit cell with a resin mold.

In JP 2004-221026 A (see particularly FIGS. 1 and 5) and JP 2003-17022 A (see particularly FIGS. 3 and 4), external connection terminals are placed on the upper surface of a circuit board, and the circuit board and so on are integrated with a unit cell with a resin mold in a state in which the external connection terminals are exposed on the upper surface of the battery pack.

Moreover, JP 2003-308881 A (see particularly FIG. 1) and JP 2004-335387 A (see particularly FIGS. 1 through 3) each discloses a battery pack in which the upper cover, the circuit board and so on are placed on the upper side of the unit cell. Furthermore, in JP 2003-308881 A, the upper cover is integrated with the upper surface of the unit cell with a resin mold in a state in which the upper cover that covers the circuit board is fixed on the upper surface of the unit cell.

When the battery pack is mounted in a mounting section of external equipment such as a portable telephone or a charger, a positioning member or the like of the mounting section is brought in contact with the upper surface of the battery pack. In this case, according to the technique of covering the upper side of the circuit board with a resin mold as shown in JP 2003-17022 A, the strength of the upper surface of the battery pack in contact with the positioning member or the like is insufficient.

As disclosed in JP 2004-221026 A, it can be considered to provide an opening that faces the external connection terminals of the circuit board for a cover made of a synthetic resin of a large strength, cover the whole body of the circuit board with the cover with the external connection terminals exposed via the opening and integrate the cover with the circuit board with the unit cell with a resin mold in this state. However, since the whole body of the circuit board is covered with the cover in JP 2004-221026 A, time and labor are consumed for the assembling work, worsening the productivity of the battery pack.

It can also be considered to place a cover only on the upper side of the circuit board for the simplification of the assembling work and integrate the cover, the circuit board and so on with the unit cell with a resin mold. In this case, it is necessary to prevent the molten resin from covering the external connection terminals through a space between the upper cover and the circuit board.

In JP 2003-308881 A, the upper cover is fixed on the upper surface of the unit cell by transforming the cover in a rivet-like shape, and thereafter, a resin mold is formed. Therefore, time and labor are consumed for the manufacturing of the battery pack by the fixing work of the upper cover.

### SUMMARY OF THE INVENTION

An object of the present invention is to provide a battery pack capable of preventing the molten resin from covering the external connection terminals through a space between the upper cover and the circuit board and efficiently integrating the upper cover with the upper surface of the unit cell with a resin mold in a state in which the upper cover and the upper surface of the unit cell are set apart at an appropriate spacing.

The battery pack of the present invention is characterized in that it includes an upper cover placed on an upper side of a unit cell, and a resin mold that is formed in between the upper cover and an upper surface of the unit cell and integrates the upper cover with the upper surface of the unit cell, and

a positioning projection is provided projecting downward on a lower surface of the upper cover in order to regulate spacing between the upper cover and the upper surface of the unit cell. In this case, at least one positioning projection is provided on the lower surface of the upper cover.

In the battery pack of the present invention, electrical components are placed on the upper side of the unit cell, and the upper cover is placed on the upper side of the electrical components. The resin mold may integrate the electrical components with the upper cover on the upper surface of the unit cell. In this case, the electrical components include a circuit board, a PTC (positive temperature coefficient) element, lead wires and so on.

Moreover, in the battery pack of the present invention, an external connection terminal is placed on an upper surface of the circuit board of the electrical components, the upper cover has a window that is provided in a penetrating form facing the external connection terminal, and a board fitting portion in which the circuit board is fit may be formed recessed on the lower surface of the upper cover. Here are included a case where the entire thickness of the circuit board is fit in the board fitting portion and a case where only part of the thickness of the circuit board is fit in the board fitting portion. Moreover, a gap between the inner surface of the board fitting portion and the circuit board when the circuit board is fit in the board fitting portion should preferably be as small as possible (including zero).

Moreover, in the battery pack of the present invention, the upper cover may have an anchor means for preventing the upper cover from coining off the resin mold. In this case, the anchor means may be a recess portion formed in a recess form at the positioning projection. Otherwise, the anchor means may be an anchor portion that is provided projecting downward from the lower surface of the upper cover and has a through hole or a recess portion provided on its side surface.

Moreover, in the battery pack of the present invention, an engagement portion is provided on the lower surface of the upper cover, and the upper cover may be fixed to the circuit board by the engagement portion in a state in which the circuit board is fit in the board fitting portion.

Moreover, in the battery pack of the present invention, a tape fitting portion, in which a double-faced tape is fit, is formed in a recess form on the upper surface of the board fitting portion, and the upper cover may be fixed to the upper surface of the circuit board by the double-faced tape. Here are included a case where the entire thickness of the double-faced tape is fit in the tape fitting portion and a case where only part of the thickness of the double-faced tape is fit in the tape fitting portion.

According to the battery pack of the present invention, the upper cover is pushed by, for example, the inner surface of a metal mold when an intermediary assembly of the battery pack is placed in the metal mold for the molding of the resin mold, the lower end of the positioning projection is brought in contact with the upper surface of the unit cell, and the spacing between the upper cover and the upper surface of the unit cell is regulated to a prescribed spacing. Therefore, a gap for injecting a molten resin in between the upper cover and the upper surface of the unit cell is reliably secured, and the electrical equipments such as lead wires, the PTC element, the circuit board and so on placed between the upper cover and the unit cell can be prevented from coming in contact with one another possibly caused by excessive mutual adjacency.

The spacing between the upper cover and the upper surface of the unit cell is regulated by the positioning projection and has a reduced chance of its varying every battery pack. Therefore, the accuracy of the vertical dimension of the battery pack after the molding of the resin mold can be maintained high, so that the reliability of manufacturing of the battery pack can be increased. This obviates the need for fixing the upper cover to the upper surface of the unit cell by means of a rivet or the like for the regulation of the spacing between the upper cover and the upper surface of the unit cell and allows the time and labor for manufacturing the battery pack to be reduced by that much.

Providing the anchor means for the upper cover prevents the upper cover from coming off the resin mold after the molding of the resin mold and from moving toward the upper side of the unit cell. The accuracy of the vertical dimension of the battery pack can be maintained high even in this point, and the reliability of manufacturing of the battery pack can be improved.

By fitting the circuit board in the board fitting portions provided for the upper cover with no gap, the molten resin does not flow around the upper surface of the circuit board during the molding of the resin mold, and the external connection terminal located on the upper surface of the circuit board can be prevented from being covered with the resin mold. On the other hand, even in a case where a minute gap is formed in between the inner surface of the board fitting portion and the circuit board when the circuit board is fit in the board fitting portions, the molten resin that enters the gap between the inner surface of the board fitting portion and the side surfaces of the circuit board from the lower end of the board fitting portion flows upward through the gap and thereafter changes its course at the upper end of the board fitting portion to try to flow through the gap between the upper surface of the circuit board and the upper surface of the board fitting portion. That is, a flow path from the lower end of the board fitting portion to the external connection terminal of the circuit board is increased in length by the fitting of the circuit board in the board fitting portion. In addition, a flow path resistance is increased by the change in the flow direction of the molten resin at the upper end of the board fitting portion, and it becomes difficult for the molten resin to reach the external connection terminal. Therefore, the molten resin is prevented from flowing over the external connection terminal during the molding of the resin mold, and the external connection terminal can reliably be connected to the contact terminal of the external equipment via, for example, the window of the upper cover.

When the upper cover is fixed to the circuit board with an engagement portion or the upper cover is fixed to the circuit board with a double-faced tape, the upper cover can reliably be prevented from separating from the circuit board before the molding of the resin mold. Therefore, the gap between the upper surface of the circuit board and the upper surface of the board fitting portion can reliably be prevented from increasing, and the molten resin can more reliably be prevented from flowing over the external connection terminal.

If the double-faced tape is made to fit in the tape fitting portion of the upper cover, the existence of the double-faced tape can reduce the chance of increasing the gap between the upper surface of the circuit board and the upper surface of the board fitting portion, and the molten resin can more reliably be prevented from flowing over the external connection terminal also from this point.

### BRIEF DESCRIPTION OF THE DRAWINGS

The present invention will be further described with reference to the accompanying drawings wherein like reference numerals refer to like parts in the several views, and wherein:*

FIG. 1 is a perspective view of an upper cover of a battery pack of a first embodiment;

FIG. 2 is an exploded perspective view of an intermediary assembly of the battery pack of the first embodiment;

FIG. 3 is a vertical sectional front view of the battery pack of the first embodiment;

FIG. 4 is a partially enlarged view of FIG. 3 showing the essential part of the battery pack of the first embodiment;

FIG. 5A is a sectional view taken along the line B-B of FIG. 4;

FIG. 5B is a sectional view taken along the line A-A of FIG. 3;

FIG. 6 is a front view of the battery pack of the first embodiment;

FIG. 7 is a perspective view of an upper cover of a second embodiment;

FIG. 8 is a vertical sectional side view showing the essential part of the second embodiment;

FIG. 9 is a perspective view of an upper cover of a battery pack of a third embodiment; and

FIG. 10 is a vertical sectional side view of the upper cover of the third embodiment.

### DETAILED DESCRIPTION OF THE PREFERRED EMBODIMENTS

### The First Embodiment

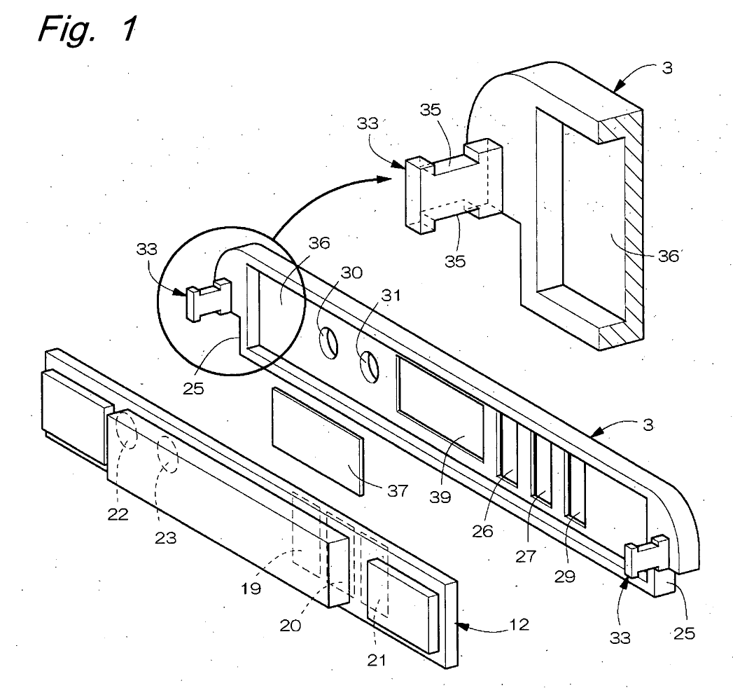

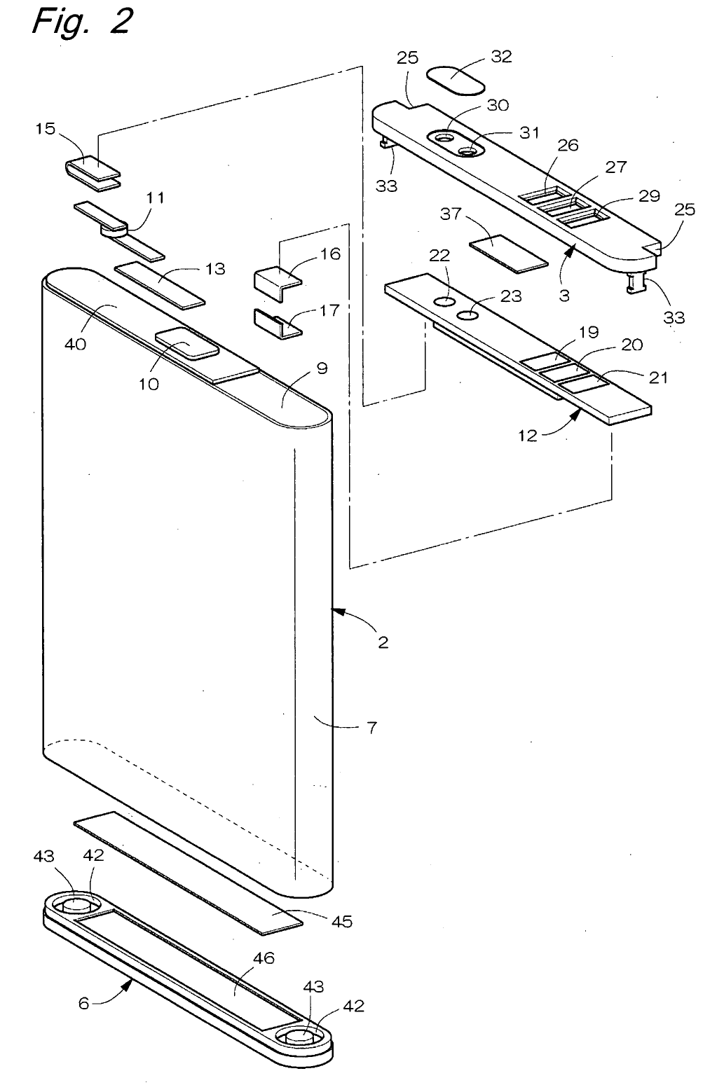

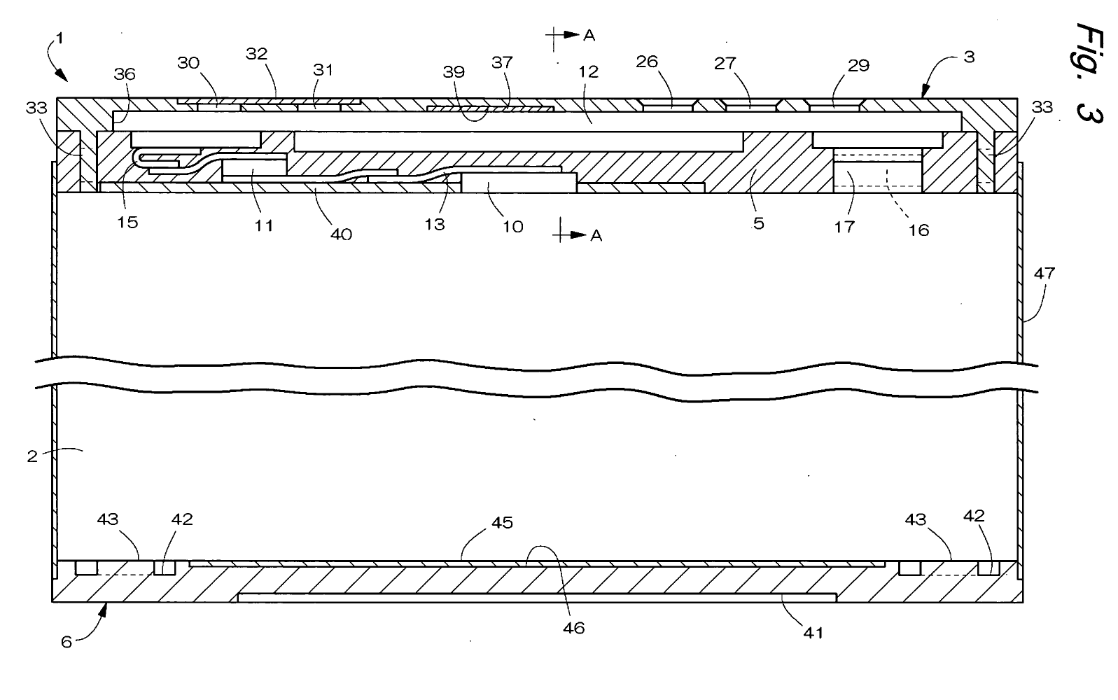

FIGS. 1 through 6 show the first embodiment of the battery pack of the present invention. As shown in FIGS. 2 and 3, the battery pack 1 of the present invention includes a flat prismatic box shaped unit cell 2, electrical components placed on the upper side of the unit cell 2, a plastic upper cover 3 placed on the upper side of the electrical components, a resin mold 5 that integrates the electrical components with the upper cover 3 on the upper surface of the unit cell 2, and a plastic lower cover 6 fixed to the lower surface of the unit cell 2. The unit cell 2 has, for example, a lateral width dimension of 33.8 mm, a vertical height dimension of 46 mm and a depthwise thickness dimension of 44.5 mm.

The resin mold 5 is formed of, for example, a polyamide based resin or a polyester based resin and insulates and protects the electrical components from the outside. As shown in FIG. 2, the unit cell 2 has a depthwise thickness dimension smaller than the vertical height dimension and the lateral width dimension thereof. The unit cell 2 has an electrode body and an electrolyte enclosed in an exterior can 7 and is constructed of a rechargeable secondary cell, or in concrete, a lithium-ion cell. In the unit cell 2, the exterior can 7 has an upper surface closed with a sealing plate 9, and a negative pole terminal 10 is provided at the center of the sealing plate 9.

The exterior can 7 is formed by deep drawing a plate material made of, for example, aluminum or its alloy. The sealing plate 9 is formed by press working a plate material of an aluminum alloy or the like. The electrode body is formed by winding a positive pole sheet that uses, for example, LiCoO₂ as a positive pole active material and a negative pole sheet that uses, for example, graphite as a negative pole active material in a spiral form with interposition of a separator made of a resin and has its whole body pressed flat.

The electrical components include a PTC element 11 placed on the upper side of the unit cell 2, a laterally elongated circuit board 12 placed on the upper side of the PTC element 11, and lead wires and lead plates, which will be described later. When a charge or discharge current of the unit cell 2 exceeds a set point, the PTC element 11 compulsorily reduces the current. The PTC element 11 is connected to the negative pole terminal 10 via a strip-shaped terminal side lead wire 13 and connected to the circuit board 12 via a strip-shaped board side lead wire 15. The circuit board 12 is connected to the sealing plate 9 of the unit cell 2 via a pair of lead plates 16 and 17 bent in an L-figured shape. The board side lead wire 15 is bonded to the lower surface located at the left-hand end of the circuit board 12 in a state in which it is curved in a U-figured shape.

The circuit board 12 has a protection circuit for limiting the charge and discharge currents of the unit cell 2, and external connection terminals 19, 20 and 21 are arranged laterally side by side while being placed to the right-hand side of the upper surface of the circuit board 12. The external connection terminals 19, 20 and 21 serve to input and output charge and discharge currents to and from the unit cell 2 by contact connection with the contact terminals of external equipment such as a portable telephone or a charger. A pair of inspection terminals 22 and 23 for inspecting the performance of the battery pack 1 are arranged laterally side by side while being placed to the left-hand side of the upper surface of the circuit board 12.

The lead wires 13 and 15 and the lead plates 16 and 17 are formed by cutting a thin plate of a conductive metal such as aluminum or nickel. By temporarily assembling the electrical components and the upper cover 3 on the upper side of the unit cell 2, a resin mold 5 is formed on the intermediary assembly.

Cut portions 25 and 25 to be engaged with positioning projections of the external equipment are formed at both right-hand and left-hand ends of the upper cover 3. The upper cover 3 has three windows 26, 27 and 29 that face the external connection terminals 19, 20 and 21 and two windows 30 and 31 that face the inspection terminals 22 and 23 in a penetrating form, and a water submergence seal 32 is attached to close the upper surface of the windows 30 and 31.

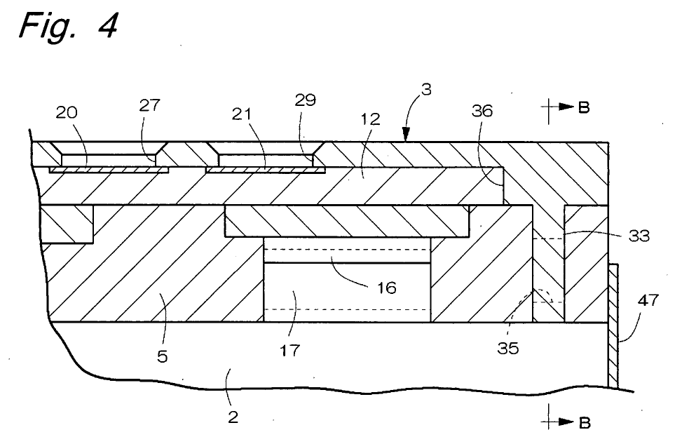

As shown in FIGS. 1 and 2, positioning projections 33 and 33 of prescribed dimensions are provided projecting downward at both right-hand and left-hand ends of the upper cover 3. By making the lower ends of the positioning projections 33 come in contact with the upper surface of the sealing plate 9 of the unit cell 2 as shown in FIGS. 3 and 4, a spacing between the upper cover 3 and the upper surface of the unit cell 2 is regulated to a prescribed spacing. The positioning projections 33 have a vertical dimension of, for example, 2 mm.

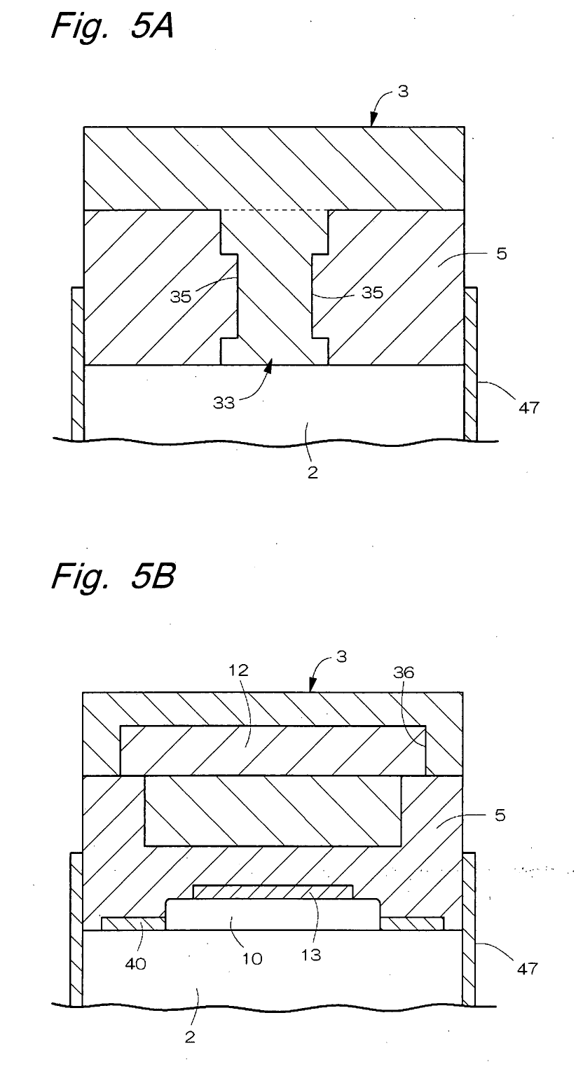

As shown in FIG. 1, each of the positioning projections 33 has a plate-like shape whose lateral width is smaller than the depthwise width (vertical width in FIG. 1), and a pair of rectangularly recessed depthwise recess portions (anchor means) 35, 35 are provided at the front and rear edges intermediately in the vertical direction of each of the positioning projections 33. By making the resin mold 5 enter the recess portions 35, 35 as shown in FIG. 5A, the upper cover 3 is prevented from coming off the resin mold 5.

As shown in FIGS. 1, 3 and 4, a laterally elongated board fitting portion 36 in which the circuit board 12 is fit is formed recessed on the lower surface of the upper cover 3. A tape fitting portion 39 in which a double-faced tape 37 is fit is formed recessed laterally in the middle of the board fitting portion 36. The upper cover 3 is stuck and fixed to the circuit board 12 by the double-faced tape 37. An insulating seal 40 is laid from the neighborhood of a lateral center portion to the left-hand end on the upper surface of the sealing plate 9 of the unit cell 2 as shown in FIGS. 2, 3 and 5B, and the insulating seal 40 prevents the PTC element 11, the terminal side lead wire 13 and the board side lead wire 15 from coming in contact with the sealing plate 9 of the unit cell 2.

As shown in FIG. 3, a fitting recess portion 41 in which the fitting portion of the external equipment is fit is formed on the lower surface of the lower cover 6. As shown in FIG. 2, an adhesion portion 43 surrounded by a ring-shaped groove 42 is provided at both the right-hand and left-hand ends of the upper surface of the lower cover 6, and a tape fitting portion 46 in which a double-faced tape 45 is fit is provided recessed in a lateral center portion of the upper surface of the lower cover 6. An adhesive is applied to the adhesion portion 43, and the lower cover 6 is stuck to the lower surface of the unit cell 2 by the adhesive and the double-faced tape 45.

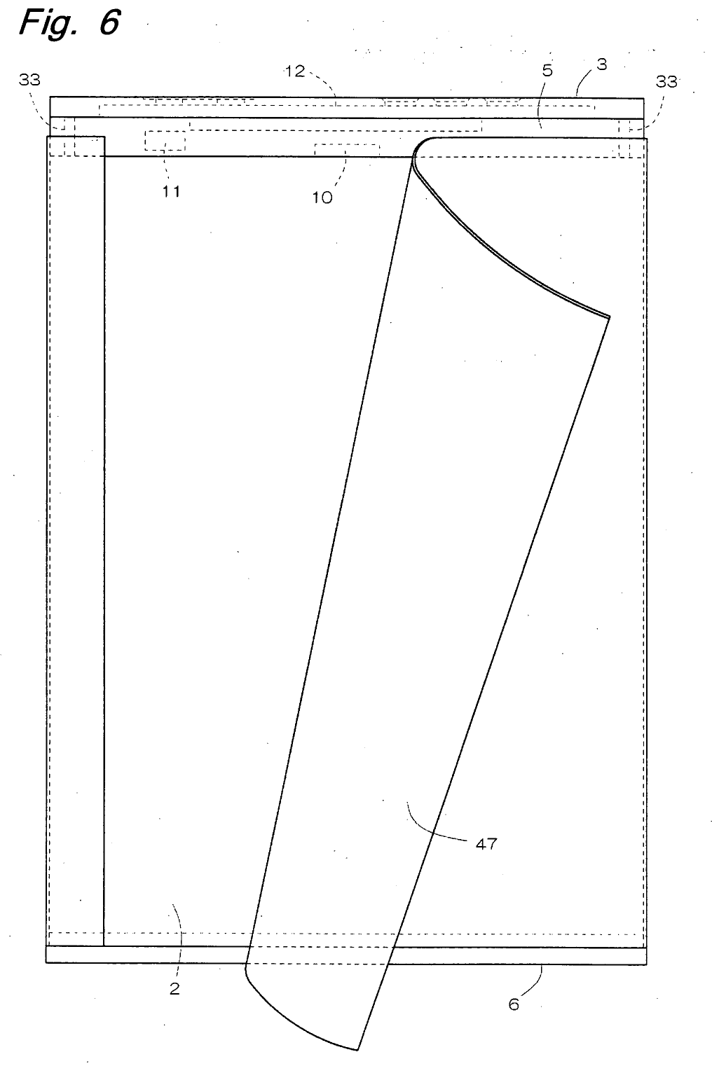

As shown in FIG. 6, the front, back, left-hand and right-hand peripheral surfaces of the unit cell 2 are covered with a label 47 that has an insulation property and is stuck to the surfaces. A print of a prescribed logotype or the like is printed on the outer surface of the label 47.

A procedure for assembling the battery pack 1 is described next. One end of the terminal side lead wire 13 is connected to one end of the PTC element 11, and the other end of the lead wire 13 is connected to the negative pole terminal 10. Moreover, one end of the board side lead wire 15 is connected to the other end of the PTC element 11, and the other end of the lead wire 15 is connected to the left-hand end portion of the circuit board 12.

The lead plate 16 is connected to the right-hand end portion of the circuit board 12, and the lead plate 17 is connected to the right-hand side of the upper surface of the sealing plate 9 of the unit cell 2. The circuit board 12 is placed on the upper side of the unit cell 2 with the board side lead wire 15 curved in a U-figured shape, and the lead plate 16 and the lead plate 17 are connected together. The double-faced tape 37 is stuck to the upper cover 3, and the upper cover 3 is fixed to the circuit board 12 by fitting the circuit board 12 in the board fitting portion 36 of the upper cover 3, forming an intermediary assembly.

By placing the intermediary assembly in a metal mold for molding the resin mold 5, the upper cover 3 is pushed by the inner surface of the metal mold, and the lower ends of the positioning projections 33 are brought in contact with the upper surface of the sealing plate 9 of the unit cell 2, regulating the spacing between the upper cover 3 and the upper surface of the unit cell 2 to a prescribed spacing. In the above state, the resin mold 5 is formed in between the upper cover 3 and the upper surface of the unit cell 2.

In this case, when the circuit board 12 is fit in the board fitting portion 36 provided for the upper cover 3 with no gap, the molten resin does not flow around the upper surface of the circuit board 12 during the molding of the resin mold 5, so that the external connection terminals 19, 20 and 21 located on the upper surface of the circuit board 12 can be prevented from being covered with the molten resin. On the other hand, even in a case where a minute gap is formed in between the inner surface of the board fitting portion 36 and the circuit board 12 when the circuit board 12 is fit in the board fitting portion 36, the molten resin that has entered the gap between the inner surface of the board fitting portion 36 and the side surfaces of the circuit board 12 from the lower end of the board fitting portion 36 during the molding of the resin mold 5 flows upward through the gap and thereafter tries to change its course at the upper end of the board fitting portion 36 and to flow through the gap between the upper surface of the circuit board 12 and the upper surface of the board fitting portion 36. That is, the flow path of the molten resin from the lower end of the board fitting portion 36 to the external connection terminals 19, 20 and 21 of the circuit board 12 is increased by the fitting of the circuit board 12 into the board fitting portion 36, and, in addition, the flow path resistance is increased by the change in the flow direction of the molten resin at the upper end of the board fitting portion 36, making it difficult for the molten resin to reach the external connection terminals 19, 20 and 21. Therefore, the molten resin is prevented from flowing over the external connection terminals 19, 20 and 21 during the molding of the resin mold 5, so that the external connection terminals 19, 20 and 21 can reliably be in contact connection to the contact terminals of the external equipment via the windows 26, 27 and 29 of the upper cover 3.

After the molding of the resin mold 5, an adhesive is applied to the adhesion portions 43 of the lower cover 6, and the lower cover 6 is stuck to the lower surface of the unit cell 2 by the adhesive and the double-faced tape 45. The label 47 is affixed to the front, back, left-hand and right-hand peripheral surfaces of the unit cell 2, and the water submergence seal 32 is stuck to the upper surface of the upper cover 3. As a result, the assembling of the battery pack 1 is completed.

### The Second Embodiment

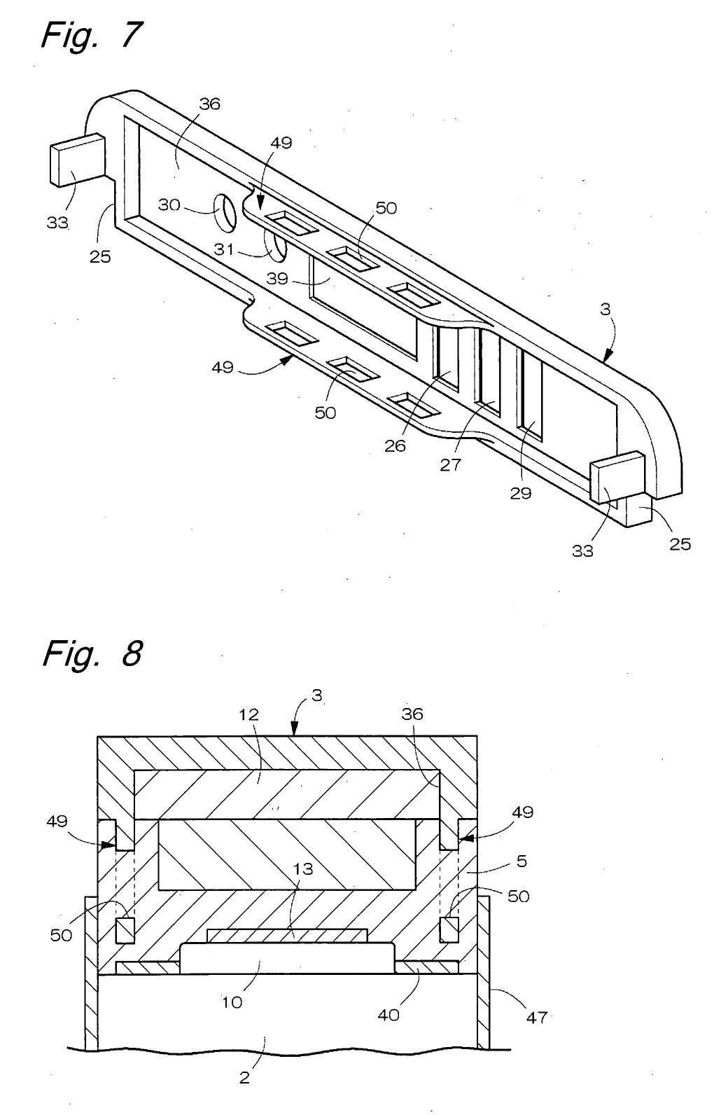

In the second embodiment, plate-shaped anchor portions 49, 49 are provided as anchor means projecting downward at the front and rear edges (upper and lower positions in FIG. 7) laterally in the middle of the lower surface of the upper cover 3 as shown in FIG. 7 instead of the formation of the positioning recess portions 35, 35 at the positioning projections 33 of the upper cover 3.

Three through holes 50 through which the molten resin of the resin mold 5 passes are arranged laterally side by side penetrating the side surfaces of the anchor portions 49. The anchor portions 49 have a vertical dimension smaller than the vertical dimension of the positioning projections 33, so that the spacing regulation by the positioning projections 33 is not obstructed. Since the other points are the same as those of the first embodiment, no description is provided therefor.

In the second embodiment, by making the resin mold 5 enter the through holes 50 of the anchor portions 49 as shown in FIG. 8, the upper cover 3 is prevented from coming off the resin mold 5. It is noted that the number of the through holes 50 arranged at the anchor portions 49 may be at least one. The anchor portions 49 may be provided separately from the positioning projections 33 or provided continuously to the positioning projections 33. Moreover, a recess portion may be formed on one side or both sides of the anchor portions 49 in place of the through holes 50.

### The Third Embodiment

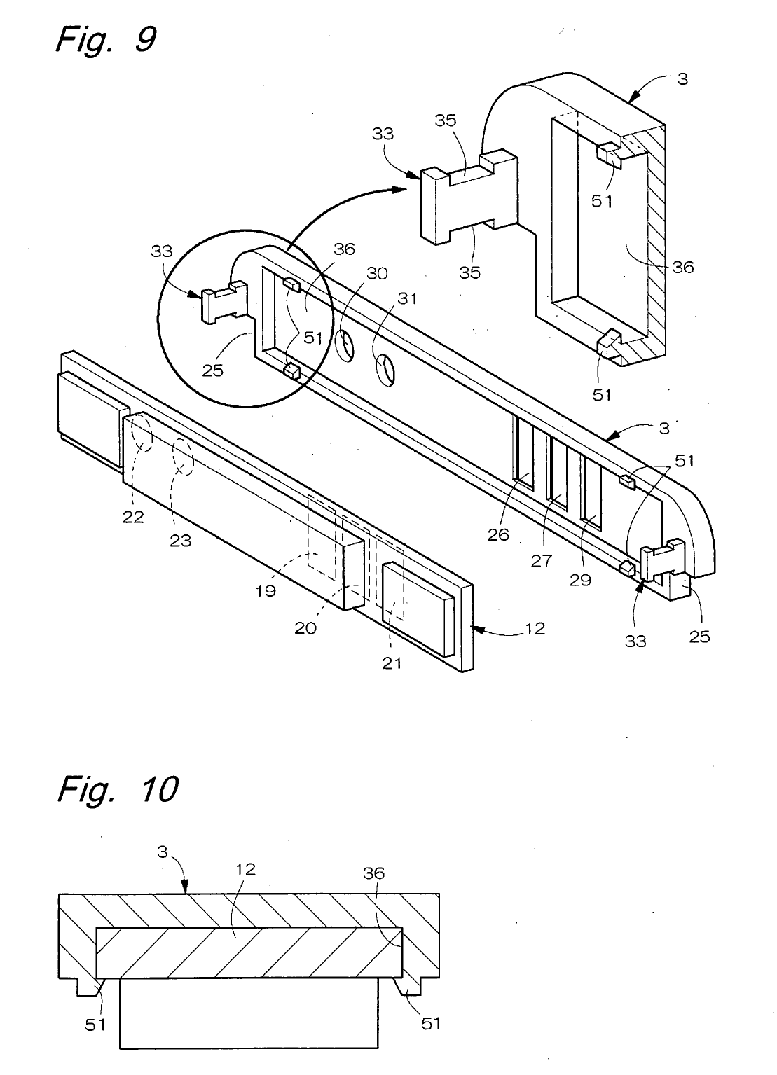

In the third embodiment, engagement portions 51 are provided projecting downward to the right-hand and left-hand ends at the front and rear edges of the upper cover 3 as shown in FIG. 9 in place of the double-faced tape 37 and the tape fitting portion 39 for sticking the upper cover 3 to the circuit board 12.

As shown in FIG. 10, the engagement portions 51 are formed in a hook-like shape overlapping the board fitting portion 36 and fixes the upper cover 3 to the circuit board 12 in an engagement manner by the engagement portions 51. That is, by pressurizing the lower surface side of the upper cover 3 against the circuit board 12, the circuit board 12 fits in the board fitting portion 36 pushing aside the engagement portions 51. Then, the engagement portions 51 are restored into the state of FIG. 10 to hook the lower surface of the circuit board 12, by which the upper cover 3 is fixed to the circuit board 12.

It is noted that the engagement portions 51 have tapered surfaces on the board fitting portion 36 side. Since the other points are the same as the first embodiment, no description is provided therefor.

In each of the above embodiments, the gap between the inner surface of the board fitting portion 36 and the circuit board 12 should preferably be as small as possible (including zero) and should preferably be, in concrete, not greater than 0.1 mm.

Although the present invention has been fully described by the illustrated methods with reference to the accompanying drawings, various modifications and corrections are apparent to those skilled in the art. It should be appreciated that such modifications and corrections are included within the scope of the present invention unless they depart from the spirit and scope of the present invention.

What is claimed is:

1. A battery pack comprising:
an upper cover placed on an upper side of a unit cell, and a resin mold that is formed in between the upper cover and an upper surface of the unit cell and integrates the upper cover with the upper surface of the unit cell, wherein
a positioning projection is provided projecting downward on a lower surface of the upper cover in order to regulate spacing between the upper cover and the upper surface of the unit cell.

2. The battery pack as claimed in claim 1, wherein
electrical components are placed on the upper side of the unit cell, the upper cover is placed on an upper side of the electrical components, and the resin mold integrates the electrical components with the upper cover on the upper surface of the unit cell.

3. The battery pack as claimed in claim 2, wherein
an external connection terminal is placed on an upper surface of the circuit board of the electrical components,
the upper cover has a window that is provided in a penetrating form facing the external connection terminal, and
a board fitting portion in which the circuit board is fit is formed recessed on the lower surface of the upper cover.

4. The battery pack as claimed in claim 1, wherein
the upper cover has an anchor means for preventing the upper cover from coming off the resin mold.

5. The battery pack as claimed in claim 4, wherein
the anchor means is a recess portion formed in a recess form on the positioning projection.

6. The battery pack as claimed in claim 4, wherein
the anchor means is an anchor portion that is provided projecting downward from the lower surface of the upper cover and has a through hole or a recess portion on its side surface.

7. The battery pack as claimed in claim 3, wherein
an engagement portion is provided on the lower surface of the upper cover, and
the upper cover is fixed to the circuit board by the engagement portion in a state in which the circuit board is fit in the board fitting portion.

8. The battery pack as claimed in claim 3, wherein
a tape fitting portion, in which a double-faced tape is fit, is formed recessed on the upper surface of the board fitting portion, and the upper cover is fixed to the upper surface of the circuit board by the double-faced tape.
